(19) United States
(12) Patent Application Publication
(10) Pub. No.: US 2011/0252305 A1
(43) Pub. Date: Oct. 13, 2011

(54) CAPTURING THE VISUAL CONTENT OF BROWSER WINDOWS

(75) Inventors: Mirko Tschäni, Basel (CH); Luc Haldimann, Pratteln (CH)

(73) Assignee: UNBLU INC., Sarnen (CH)

(21) Appl. No.: 13/123,465

(22) PCT Filed: Oct. 12, 2009
(86) PCT No.: PCT/CH2009/000326

§ 371 Date: Apr. 8, 2011

(30) Foreign Application Priority Data
Oct. 16, 2008 (CH) 1633/08

(51) Int. Cl. G06F 17/00

(52) U.S. Cl. 715/234

(57) ABSTRACT

In a method for capturing the display of at least one document displayed in at least one browser display unit (4), wherein the browser display unit (4) is generated by a browser program executed on a source computer and the browser program generates a document object model (2) as interface for access to the document displayed in the browser display unit (4), the display objects (21) of the document object model (2) which are relevant to the display of the document in the browser display unit (4) are captured at least partially in a predefined data structure (3), and the document object model (2) is monitored so that changes of the display objects (21) of the document object model (2) are captured. The method of the invention enables an automated, efficient and generic capturing of the display of a document displayed by means of the browser program, for example a webpage. The method of the invention can enable an efficient operation of different appropriate applications.

### TECHNICAL FIELD

The invention relates to a method for capturing the visual content of a browser window as well as to a computer program for carrying out the method of the invention and a communication device for carrying out the method of the invention. Methods of this kind, in which at least one browser display unit is generated by a browser program executed on a source computer and in which the browser program generates a document object model as interface for accessing at least one document displayed in the browser display unit, can be used for capturing the display or representation of the document displayed in the browser display unit.

### PRIOR ART

For finding, displaying and editing information on a computer or a computer network, often browser programs are used which are executed on the computer and operated by a user. The information is typically provided by a server service which is executed, for example, on a server computer that is remote from the computer and connected therewith via a communication network. For the browser program being able to display and edit the information in a predefined manner, the information is provided in a predefined format by the server service. Browser programs normally have a display module, wherein they reproduce the information either in mere text form in the display module or in graphically processed form.

As the Internet has spread out as world wide communication network, in particular also the World Wide Web System (WWW) has established all over the world. In the WWW server computers provide information via the Internet to other computers connected to the Internet, wherein the information is processed in such a standardized manner that it can be displayed and edited by a browser program executed on a computer connected to the Internet. To this end, the browser program is configured such that it can receive, display and edit the information that is processed in a standardized manner and, if necessary, send information back to the server computer. For example, i.a. standards in view of the transmission protocols such as the Hypertext Transfer Protocol (HTTP) or the File Transfer Protocol (FTP), the markup languages such as the Hypertext Markup Language (HTML), and the graphic formats such as the format Joint Photographic Experts Group (JPG) or the format Graphics Interchange Format (GIF) have established in the WWW. Browser programs are available for a large variety of computer platforms, which each depend on different parameters such as the operating system, the hardware, the versioning etc. They are configured for the essentially equal standards so that the information that is processed in a standardized manner for the WWW can be provided in a manner that is substantially independent of the platform.

Typically, information provided in the WWW is organized on webpages which are composed of different objects and can be defined and structured by means of a markup language. A browser program as described above can have an interpretation unit by means of which the browser program can analyze a webpage obtained from a network, for example the Internet, and display i.a. also the objects defined on the basis of the markup language in a structured manner in the display module. For allowing an improved interaction with a user of the browser program and for being able to execute webpage-specific program logics in the browser program, also standards in view of script programming languages, for example JavaScript, have established in the WWW. The interpretation unit of the browser program typically can implement at least one of these script languages.

As the WWW becomes more and more important and the webpages become more and more complex, the maintenance, support and control of the webpages as well as the operability of the webpages by several users at the same time (collaboration) are nowadays increasingly important. To this end it might be necessary and/or helpful to capture the display of a webpage on a computer and to transmit and/or record it depending on the intended use. For example, for being able to assist and support the user of a webpage as efficiently as possible or also for carrying out other maintenance, support and control tasks, i.a. remote control software is nowadays used, by means of which the browser program of the computer can be displayed on a control computer and operated by means of the control computer, for example by using its keyboard or its mouse. By means of such a remote control software, for example, the user of a page can be trained, supported and assisted on his/her own computer, without a supporting person having to be physically present at the location of the computer at the user of the webpage.

Known remote control software of this kind allows, e.g., capturing of a displayed webpage on a computer for remotely controlling a browser program by means of embedded objects which are transmitted into the browser program together with the webpage. Such embedded objects are not interpreted and/or executed by the browser program itself but by a third-party program started via the browser program. Such likewise standardized third-party programs, for example the Java Runtime Engine (JRE) or the ActiveX components, which allow programs to be carried out substantially independent of a platform, however, have to be installed themselves in the operating system of the computer. However, since the installation of third-party programs and in particular also the execution of embedded objects by means of a third-party program can partly be relevant in view of safety, corresponding embedded objects are often undesired and/or inadmissible.

For example, the article “COLLABORATIVE ENVIRONMENT FOR SUPPORTING WEB USERS” of the author Yoshinori Aoki of IBM Research, Tokyo Research Laboratory of the year 2001 describes a system in which a proxy server extends a webpage in an automated manner by a webpage control. This extended webpage is then executed in a browser program on a client computer. In the described system, also a control panel with a node manager is transmitted in the webpage to the client computer and executed via the browser program on the client computer. For capturing the display of the webpage, the system uses the document object model (DOM) of the browser program, which was generated by the browser program as standardized interface. The document control recognizes events via the DOM, transmits them to the node manager and controls the webpage via the DOM. Both the node manager and the document control are implemented as embedded objects in Java and by means of script commands in JavaScript.

In addition to the above-mentioned installation of the third-party program on the client computer, which installation has to be carried out necessarily but is often undesired, it has to be taken into consideration in the automated addition of the webpage control by means of the proxy server in the system described above that the components of webpages which are responsible for critical application logic are not duplicated or executed at a wrong place or a wrong time. For example, in an online banking application which is carried out by means of a webpage, there is a risk that critical functionality of the application logic, such as, i.a., functionality relevant to an accounting entry, is transmitted to a further computer and executed there. This can cause erroneous entries and/or an abnormal termination of the online banking application. In order to prevent this, the webpage control can be realized such that critical application logic is recognized and cannot or can only in amended form be transmitted from the client computer to the further computer. For that purpose, the proxy server has to be adapted to corresponding webpages so that the webpage control cannot be generically added to any webpage.

Therefore, it is the object of the following invention to suggest a method for capturing the display of a webpage displayed in a browser display module, by means of which method a generic automated capturing of any webpage is possible independent of its application logic.

### DESCRIPTION OF THE INVENTION

In accordance with the invention, the object is achieved by a method as disclosed below. Advantageous embodiments of the method of the invention are also disclosed below.

The gist of the invention is as follows: In a method for capturing the display or representation of at least one document displayed in at least one browser display unit, the browser display unit is generated by a browser program executed on a source computer. The browser program generates a document object model as interface for accessing the document displayed in the browser display unit. Display objects of the document object model which are relevant to the display of the document in the browser display unit are captured at least partially in a predefined data structure. Also, the document object model is monitored such that changes of the display objects of the document object model are captured.

Herein, “browser display unit” relates to, e.g., a browser window, a frame of a browser window or also a virtual browser window or a virtual frame of a headless browser program. Thereby, “headless browser program” herein relates to a browser program which does not generate a real graphic output visible to a user and is executed, e.g., on a server computer. Moreover, “frames” herein relates to any possible kind of browser frames including iframes. The document object model generated by the browser program can, e.g., be the Document Object Model (DOM) defined by the World Wide Web Consortium (W3C). The DOM allows access to one or more document(s) displayed in one or more browser display unit(s), for example in a browser window or in several frames or also in several browser windows.

The display objects captured in the data structure are herein also descriptively indicated as “visual” or “DOM shot”. Depending on the field of application of the method according to the invention, it can also be appropriate to capture only part of the display objects which are relevant to displaying the document in the browser display unit in the data structure, which is then descriptively indicated as “partial visual”. A (partial) visual can, e.g., be structured in a tree, in particular, e.g., similar to the DOM, i.e. so as to comprise nodes with attributes and an ordered list of child nodes with corresponding attributes. “Display objects” are here understood to be all objects and information essential to displaying a document, for example graphical objects and their arrangement, event handlers as well as information about the browser window and its arrangement. In the method of the invention, other objects which are no display objects are purposefully not captured in the data structure. These other objects can, e.g., comprise all or specific script objects or specific embedded objects.

Changes of the display objects can be captured in that a further (partial) visual is generated or in that the difference between the further visual and the previous visual is captured, which here is referred to as “incremental visual” (see below). Monitoring the document object model can be carried out, i.a., in an event-driven manner or in a user-driven manner or periodically (see below). For example, all or specific ones of the event handlers of at least one document, which event handlers are predefined in a standardized manner, can be intercepted so that then a corresponding (partial or incremental) visual can be generated. Or a user of the browser program can actively trigger the generation of a visual, for example by operating a respective button.

The method of the invention allows an automated efficient generic capturing of the display of a document displayed by means of a browser program, for example a webpage. Thereby, the method of the invention can also allow an efficient operation of different applications. For example, the method can be used in an application for remotely controlling or statistically evaluating a web application executed in the browser program. Specific parts of the web application, for example one or more webpage(s), can be extended in an automated manner for carrying out the method, so that the displays of the extended webpages can be captured. The thus generated (partial or incremental) visuals can be transmitted to a further computer on which they can be stored, e.g., for evaluation purposes or on which they can be displayed in a further browser program. According to the method of the invention, on the one hand the webpages can be extended generically, i.e. independently of application logic contained in the webpages, and on the other hand the application logic can be executed at one place only, i.e. in the original browser program.

In another example, the method of the invention can be used in an application for server-side browsing. Thereby, any webpage can be accordingly extended and displayed by means of a browser program executed on a server computer. This browser program can, e.g., be a headless browser program. By the visuals generated on the server computer, the webpages can be displayed on one or more client computer(s) in a browser program. Thus, several users can work at the same time at different client computers with one single web application (collaboration). The application logic is always executed via the server computer, so that all users can use the same functionality and can also see in real time which operations are carried out by other users by means of the web application. According to the method of the invention, the webpages can be extended generically, i.e. independently of application logic contained in the webpages, and the application logic can be executed at one place only, i.e. in the browser program of the server computer.

In a further different example, the method of the invention can be used in another application for server-side browsing. As described above, specific parts of the web application, e.g. one or more webpage(s), can be extended in an automated manner for carrying out the method and displayed by means of a browser program executed on a server computer. This browser program can be, e.g., a headless browser program. Via the visuals generated on the server computer, the webpages can be displayed on one or more client computer(s) in a browser program. Since also in this example the application logic is executed on the server computer and on the client computer only the graphical representation of the webpage is displayed, the technical requirements of the client computer can be kept relatively low. This allows a relatively smooth use of relatively demanding webpages on a relatively inefficient client computer, which can be, e.g., a handheld computer, a thin client or a mobile phone. According to the method of the invention, the webpages can be extended generically, i.e. independently of application logic contained in the webpages, and the application logic can be executed at one place only, i.e. in the browser program of the server computer.

In the method of the invention, the document object model is preferably monitored by periodically checking or testing it for changes of its display objects. This periodical checking can be carried out in relatively static webpages, e.g., every two seconds and in relatively dynamic webpages, such as webpages with animated elements, every 50 to 200 milliseconds. Such a periodic checking or testing allows a relatively simple implementation of a purposive testing in the method of the invention.

Advantageously, the document object model is monitored by checking or testing it in case of a specific event for changes of its display objects. Certain events of the webpage can be intercepted in this manner and used for initiating the checking of the document object model. The events can, e.g., be the event handlers of the standardized DOM defined by the W3C, wherein also only certain event handlers can be used under specific conditions. Such an event-driven checking allows a relatively simple implementation of a well-targeted checking in the method of the invention. The two kinds of checking described can preferably also be combined.

In the method of the invention, the document is preferably extended before transmission to the source computer by a document control for capturing the display objects and the document object module and for monitoring the document object model. The transmission to the source computer can be carried out in any desired manner, for example from a web server via the Internet. Extension of the document can comprise including script commands, replacing existing objects as well as any other suitable measures. It can be carried out, e.g., (semi)-manually per document or also in an automated manner. By extending the document before transmission to the source computer, it can be guaranteed that the document is available on all connected source computers in an extended form, which is particularly advantageous if numerous source computers can access one document. Moreover, the document can thus be extended under predetermined conditions centrally at one place.

Preferably, before transmitting the program to the source computer, a proxy service extends the program by the document control in an automated manner. The proxy service can be arranged functionally between the web server and the source computer. It is thus possible to configure the document independently of the later capturability of the display objects of the document object model. In particular, no aspects of the later capturing of the display objects of the document object model have to be taken into consideration when the document is generated, e.g. by a web designer. After having been generated and designed, the document is provided, e.g., on a web server. If it is requested by a source computer on the web server, it is extended via the proxy service and transmitted to the source computer. Such an automated extension of the document by means of a proxy service allows a generic extension of documents, so that the design of the document can be separated from the extension. This allows for a relatively comfortable generation and management of the document. Moreover, it is possible to update, maintain and adapt the extension relatively simply at a central place.

The browser program advantageously comprises a script interpretation unit and the document control consists completely of script commands that can be executed by the script interpretation unit. Thus, no third-party programs for interpreting the document, for example the Java Runtime Engine, have to be installed on the source computer. This can be advantageous for safety reasons or it can help to keep the technical requirements as regards the efficiency of the source computer low.

Preferably, the changes of the display objects of the document object model are captured incrementally. To this end, only information as to changed display objects can be captured, e.g., in an incremental visual, which is then dependent on the display objects (visual or partial visual) captured in the predefined data structure. In accordance with such a capturing of the changes of the display objects of the document object model, no respective entire (partial) visuals have to be transmitted and optionally stored or displayed but only fractions thereof. Thus, the capturing of the display of the document can be relatively compact in view of the amount of data, so that relatively few storage capacity and computing power are necessary for the display and storage and so that a relatively small bandwidth is necessary for the transmission thereof. An incremental visual can comprise, e.g., an ordered list of change commands. Such change commands can comprise, e.g., the addition of a node, the removal of a node or the change of an attribute. Each change command has a target node, which can be identified, e.g., via identifiers provided for this specific purpose or via an indicated path. An incremental visual serves for modifying a full first (partial) visual in such a manner that it is then identical to a full second (partial) visual. If the full first (partial) visual is already displayed in a browser window, the incremental visual can also be used directly in the browser program by manipulating the DOM. Thus, the incremental visual can be transmitted very efficiently to an image or copy in a target browser program.

In the method of the invention, the captured data structure is preferably transmitted to a further computer and stored thereon. The further computer can be, e.g., a server computer of, e.g., the WWW or a target computer in, e.g., a Peer to Peer network via the Internet. By such a storage, e.g., the use of the document can be recorded or archived, so that, e.g., the user behavior can be analyzed or statistics relating to the document can be generated.

On the basis of data structures captured at different points in time, the change of the display objects of the document object module is advantageously captured incrementally and stored on the further computer. This incremental capturing of the change of two (partial) visuals of a document can take place either before transmission of the (partial) visual on the source computer or after transmission of the (partial) visual on the further computer. Such a capturing of the differences of a document at two different points in time allows a reduction of the storage requirements as compared to the storage of two full (partial) visuals.

Preferably, at a first point in time, a first data structure of a first document is captured and at a second point in time a second data structure of a second document is captured, wherein the differences between the first data structure and the second data structure are captured incrementally and stored on the further computer. Thus, two independent documents can be dynamically related in view of their use. In particular when the documents are similar, such a capturing of differences between two different documents can lead to a reduction in the storage requirements as compared to the storage requirements for a full (partial) visual of the first document and a full (partial) visual of the second document.

The display objects captured in the data structure and the captured changes of the display objects are advantageously transferred to a target computer on which they are displayed for displaying a document copy corresponding to the document in a target browser display unit generated by a target browser program. Thus, the document and its use can be remotely controlled on the source computer, which can be used, e.g., for remotely supporting the user.

Preferably, the display objects captured in the data structure and the captured changes of the display objects are preferably buffered in a buffer before being transmitted to the target computer. In particular in case of frequent modifications of the documents, for example in animated objects, a smooth reproduction, e.g., on the target computer is possible.

A document copy object model is advantageously monitored by testing it in case of a specific event for changes of its display objects, so that changes of the target display objects of the document copy object model, which changes are relevant to the display of the document copy in the target browser display unit, are captured and transmitted to the source computer. Thus, the remote monitoring described above can be extended to a remote control of the document and its use on the source computer, which can be used, e.g., for a more comfortable remote support of the user.

Preferably, a transmission request generated on the basis of the document displayed in the browser display unit and the response thereto are captured, wherein the response is used for a corresponding transmission request generated on the basis of the document copy displayed in the target browser display unit. The transmission request generated on the basis of the document copy can be the same or a similar adapted transmission request as that generated on the basis of the document. Documents, in particular webpages, can also comprise requests relating to objects, such as images, or data base requests as transmission requests (HTTP requests). These transmission requests are answered either after or while the document is displayed in the browser display unit by reloading the requested objects. Thus, a relatively flexible and simple management and updating of these objects is possible. Since the method of the invention captures also such transmission requests and their responses, e.g., the document can also be reproduced when it is just being used, even if the requested objects were changed later without having changed the document itself

A further aspect of the invention relates to a computer program comprising a structure or means for carrying out the described method. Such a computer program can comprise, e.g., a component for extending a webpage generated by a web design software in an automated manner, which can be implemented, e.g., as plug-in of the web design software. Or it can comprise a proxy service component for extending webpages in case of a request from a source computer continuously before transmission to the source computer.

A different further aspect of the invention relates to a communication device comprising a structure or means for carrying out the described method.

### BRIEF DESCRIPTION OF THE DRAWINGS

Further advantageous embodiments of the invention can be taken from the following description of embodiments of the invention based on the schematic drawings in which

FIG. 1 shows a functional diagram of an example of the method of the invention;

FIG. 2 shows a functional diagram of the method of FIG. 1 with a proxy service with respect to the display of a webpage; and

FIG. 3 shows a functional diagram of the method of FIG. 2 with respect to the display of a webpage copy.

### WAY(S) FOR CARRYING OUT THE INVENTION

FIG. 1 shows an embodiment of the method of the invention, in which a webpage 1 as a document is transmitted in a browser program on a source computer. The webpage 1 comprises different objects which are defined by means of HTML 11 as markup language. From the objects defined in the webpage, the browser program generates a DOM 2 as document object model and displays the webpage 1 in a browser window 4 as browser display unit in a structured manner. The DOM 2 comprises objects which are structured like a tree and which comprise a root object 23, a plurality of visual objects 21 as objects being relevant to the display of the webpage 1 in the browser window 4, and a plurality of non-visual objects 22 as objects not being relevant to the display of the webpage in the browser window 4. The visual objects 21 can comprise, e.g., texts, images, animations, event handlers or the like, and the non-visual objects 22 can comprise, e.g., script functions consisting of script commands (JavaScript), hidden form fields, other hidden objects or the like.

Before being transmitted to the source computer, the webpage 1 is extended by script functions consisting of JavaScript commands as document control, which capture the visual objects 21 of the DOM 2 in a visual 3. The visual 3 is, e.g., structured like a tree and comprises a root object 34, a text object 31, a table object 32 as well as a frame object 43 comprising an image object 331 and a text object 332. The visual 3 comprises all visual elements used for displaying the webpage 1 in the browser window 4. Accordingly, the webpage 1 is shown in the browser window 4 exemplarily with a text 41, a table object 42 as well as a frame 43 comprising an image 431 and a text 432.

By means of the script functions, the DOM 2 is tested periodically for changes of its visual objects 21. By means of the script functions, the DOM 2 is additionally checked or tested for changes of its visual objects 21 when specific event handlers of the DOM 2 are triggered. If respective changes are found during such a check, the script functions generate a further visual. Alternatively, also only the changed visual objects 21 of the DOM 2 can be captured in an incremental visual.

In accordance with another embodiment of the method of the invention, the script functions can also capture only part of the visual objects 21 of the DOM 2 in a partial visual. For example, such a partial visual can also be structured like a tree but only comprise the visual elements of the display of the webpage 1 in the browser window 4 displayed in the frame 41, i.e. only the image object 331 and the text object 332.

The following is stipulated for the entire further description. If a Figure comprises reference numbers for the sake of illustrative clarity and if these reference numbers are not mentioned in the directly corresponding description text, reference is made to the explanation of these reference numbers in previous Figure descriptions.

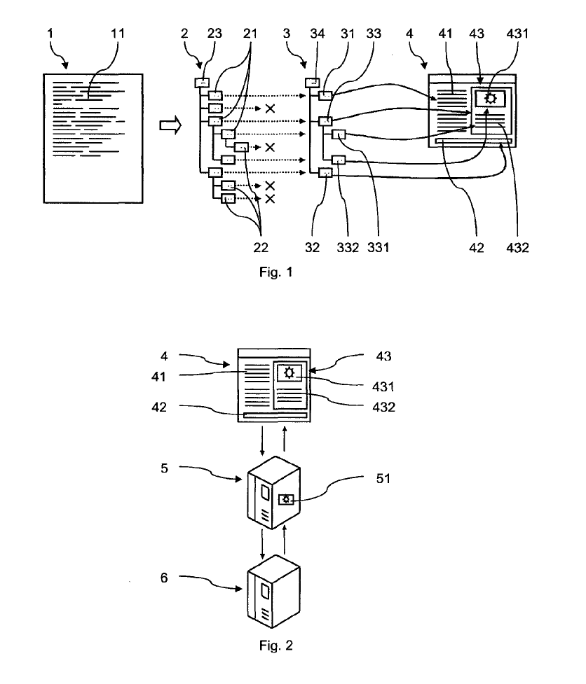

FIG. 2 shows a possible implementation of the method of the invention, wherein the webpage 1 is provided by or on a web server 6 of the WWW for access via the Internet. As indicated by the arrows, the webpage 1 is requested by a browser program executed on a source computer via a proxy server 5 on the web server 6. The webpage 1 is then transmitted in a first step from the web server 6 to the proxy server 5. On the proxy server 5, a proxy service 51 is executed which extends the webpage 1 in an automated manner by script functions consisting of JavaScript commands as document control, by means of which the display of the webpage 1 in the browser window 4 of the source computer and changes thereof can be captured.

If changes of the visual objects 21 of the DOM 2 found by means of the script functions are captured, the corresponding further visual or the incremental visual is transmitted to the proxy server 5 and, depending on the configuration of the proxy service 51, either stored or transmitted to a target computer. Further, the HTTP requests contained in the webpage 1 are requested as transmission requests via the proxy server 5 on the web server 6. These HTTP requests or HTTP requests accordingly adapted to these HTTP requests, as well as also the responses thereto, are also captured together with the visual 2.

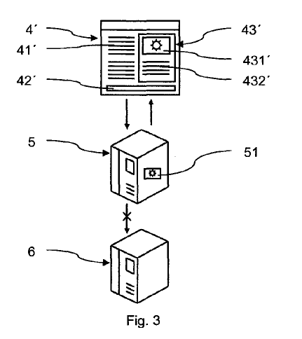

As shown in FIG. 3, in case of a request for displaying the webpage 1 displayed in the browser window 4 on the source computer on a target computer, for example for remotely monitoring or remotely controlling the webpage 1 displayed on the source computer, a webpage copy is transmitted by means of the visual 2 to the target computer and displayed there in a target browser window 4′, which is generated by a target browser program, as target browser display unit. In the target browser window 4′, the visual elements of the webpage copy corresponding to the webpage are displayed with a text 41′, a table 42′ as well as a frame 43′ comprising an image 431′ and a text 432′. Since the visual 2 does not contain the non-visual objects 22 of the webpage 1, it is guaranteed that no undesired functionality of the webpage 1 can be executed also via the webpage copy. Also, HTTP requests corresponding to the HTTP requests of the webpage 1 are transmitted in the webpage copy to the target computer, and the corresponding responses are transmitted from the proxy server 5 to the target computer. Access from the target computer to the web server 6 is not necessary in this respect.

Although the invention is depicted and described in detail on the basis of the Figures and the corresponding description, this depiction and detailed description are considered as being illustrative and exemplary and not as restricting the invention. A skilled person can of course make changes and modifications without leaving the scope and spirit of the following claims. In particular, the invention also comprises embodiments comprising any combination of features mentioned or shown above or below in connection with different embodiments. The invention also comprises individual features in the Figures, even if they are shown therein in connection with other features and/or if they are not mentioned above or below.

Moreover, the term “comprise” and derivations thereof do not exclude other elements or steps. Furthermore, the indefinite article “a” and derivations thereof do not exclude a plurality. The functions of a plurality of features mentioned in the claims can be fulfilled by a unit. A computer program can be stored and/or distributed on a suitable medium, for example on an optical storage medium or a hard medium provided together with or as part of other hardware. It can also be distributed in other form, for example via the Internet or other wired and unwired telecommunication systems. All reference numbers in the claims are not considered as restricting the scope of the claims.

1. A method for capturing the display of at least one document displayed in at least one browser display unit, wherein the browser display unit is generated by a browser program executed on a source computer and the browser program generates a document object model as interface for accessing the document displayed in the browser display unit, wherein display objects of the document object model which are relevant to the display of the document in the browser display unit are at least partially captured in a predefined data structure and the document object model is monitored such that changes of the display objects of the document object model are captured.

2. The method according to claim 1, wherein the document object model is monitored by checking it periodically for changes of its display objects.

3. The method according to claim 1, wherein the document object model is monitored by checking it in case of a specific event for changes of its display objects.

4. The method according to claim 1, wherein before being transmitted to the source computer, the document is extended by a document control for capturing the display objects of the document object model and for monitoring the document object model.

5. The method according to claim 4, wherein before being transmitted to the source computer, the document is automatically extended by the document control by means of a proxy service.

6. The method according to claim 4, wherein the browser program comprises a script interpretation unit and the document control consists completely of script commands being executable by the script interpretation unit.

7. The method according to claim 1, wherein the changes of the display objects of the document object model are captured incrementally.

8. The method according to claim 1, wherein the captured data structure is transmitted to a further computer and stored thereon.

9. The method according to claim 8, wherein from data structures captured at different points in time the changes of the display objects of the document object model are incrementally captured and stored on the further computer.

10. The method according to claim 8, wherein at a first point in time a first data structure of a first document is captured and at a second point in time a second data structure of a second document is captured, wherein the differences between the first data structure and the second data structure are incrementally captured and stored on the further computer.

11. The method according to claim 1, wherein the display objects captured in the data structure and the captured changes of the display objects are transmitted to a target computer on which they are displayed for displaying a document copy corresponding to the document in a target browser display unit generated by a target browser program.

12. The method according to claim 11, wherein the display objects captured in the data structure and the captured changes of the display objects are buffered in a buffer before being transmitted to the target computer.

13. The method according to claim 11, wherein a document copy object model is monitored by checking it for changes of its display objects in case of a specific event, such that changes of the target display objects of the document copy object model, which are relevant to the display of the document copy in the target browser display unit, are captured and transmitted to the source computer.

14. The method according to claim 11, wherein a transmission request generated from the document displayed in the browser display unit and the response thereto are captured, wherein the response is used for as the response to a corresponding transmission request generated from the document copy displayed in the target browser display unit.

15. A computer program comprising a structure for carrying out the method according to claim 1.

16. A communication device comprising a structure for carrying out the method according to claim 1.
